(19) United States
(12) Patent Application Publication
(10) Pub. No.: US 2020/0018383 A1
(43) Pub. Date: Jan. 16, 2020

(54) HYDRAULIC TENSIONER WITH MOVING SLEEVE

(71) Applicant: BorgWarner Inc., Auburn Hills, MI (US)

(72) Inventors: XiaoJian Lu, Shanghai (CN); Jun Song, Shanghai (CN)

(21) Appl. No.: 16/034,626

(22) Filed: Jul. 13, 2018

(51) Int. Cl. F16H 7/08; F15B 15/26; F15B 13/02

(52) U.S. Cl. CPC F16H 7/0848; F15B 15/261; F15B 13/027; F16H 2007/0855; F16H 2007/0853; F16H 2007/0859; F16H 2007/0812

(57) ABSTRACT

Provided are tensioners to tension a closed loop chain of a chain drive system. The tensioners can include a housing with an open end, an enclosed end opposite the open end including an inlet supply, a bore extending from the open end to an area directly above the inlet supply to form a housing seat, a movable sleeve formed in the housing bore having an open end adjacent the open end of the housing, a closed end in contact with the housing seat, a sleeve bore extending from the open end to the closed end and a controlled inlet formed through the closed end thereof, a hollow piston disposed in the sleeve bore and a spring disposed in the piston bore to apply a bias on the piston outward from the sleeve bore.

### BACKGROUND OF THE INVENTION

### Field of the Invention

The invention pertains to the field of tensioners. More particularly, the invention pertains to a hydraulic tensioner with a moving sleeve or base within a housing of the tensioners.

### Description of Related Art

Generally, timing chains for valve drives of internal combustion engines, camshaft chains in use for a camshaft-camshaft drive, and balancer chains, have tensioners that are used on the slack side of a chain to take up slack in the chain and to apply tension to the chain.

During operation, a piston of the tensioner presses against the chain to maintain tension in the chain. When tension in the chain increases during operation due to resonance of a chain span, a high load from the chain acts on the piston of the tensioner, causing the piston to extend outward as the tensioner pumps up to keep the tension in the chain.

Chain drive tensioner spring force is often too high for most operating conditions because the spring force needs to be sufficient to handle worst case operating conditions of a tensioner system. The effectiveness of the tensioner and the overall system behavior and efficiency could be improved if the tensioner spring force could be varied with operating conditions, taking into account wear and stretching that occurs in the chain during the life of the chain.

Chain drive tensioners can increase in lifespan by increasing the extension of a piston therein.

Chain drive tensioners can improve in performance by controlling the movement of a piston with respect to a tensioner housing solely by hydraulic pressures.

### SUMMARY OF THE INVENTION

A hydraulic tensioner that has a moving sleeve with a ratchet function within the housing. The moving sleeve eliminates the difference between different piston positions for tensioner function.

The foregoing and other features and utilities of the present inventive concept can be achieved by providing a tensioner including housing having an open end, an enclosed end opposite the open end, an inlet fluid supply formed in the enclosed end, a housing bore extending from the open end through the housing to a seat formed directly above the inlet fluid supply, and a ratchet clip disposed in a groove formed circumferentially around the housing bore adjacent to the open end thereof; a movable sleeve slidingly disposed in the housing bore, the sleeve including an open end adjacent the open end of the housing, a closed end in contact with the seat, a bore extending from the open end through the sleeve to the closed end, and ratchet teeth formed along an outer circumference thereof such that the ratchet clip frictionally engages with consecutive ratchet teeth as the sleeve moves outward of the housing bore; and a piston slidingly disposed in the sleeve bore, the piston having a closed end adjacent the open end of the sleeve, an open end in fluid communication with the sleeve bore to form a high pressure chamber, and a piston spring extending from an inner side of the closed end to the check valve.

In an example embodiment, fluid provided by the inlet fluid supply forces the moveable sleeve and piston to slide away from the housing seat.

In another example embodiment, the sleeve further may further include a controlled inlet extending through the closed end of the sleeve to control a flow of fluid into the sleeve bore.

In another example embodiment, the controlled inlet of the sleeve may include a check valve fixed thereto and the closed end of the sleeve forms a seat for the check valve.

In still another example embodiment, tensioner can further include at least one slot formed lengthwise through the piston; and at least one pin extending inward from a wall of the sleeve bore through a corresponding at least one slot, the at least one slot having a length to control sliding movement of the piston along a length of the sleeve bore.

The foregoing and other features and utilities of the present inventive concept can also be achieved by providing a tensioner including: a housing having an open end, an enclosed end opposite the open end, an inlet fluid supply formed in the enclosed end to receive fluid from an external source, a housing bore extending from the open end to a seat formed directly above the inlet fluid supply, and an extension extending outward from the housing and forming an extension bore in communication with the housing bore; a movable base disposed in the housing bore and having an open end facing toward the open end of the housing, a closed end including a fluid controlled inlet extending therethrough resting on the housing seat, a bore extending from the open end to the closed end, and ratchet teeth formed along a length of a section of the outer surface of the base facing the extension bore; a pawl having pawl ratchet teeth, the pawl slidingly received within the extension and continuously biased to engage the pawl ratchet teeth with the ratchet teeth of the moveable base; a piston slidingly disposed in the housing bore, the piston including a closed end adjacent the open end of the housing, an open end facing the open end of the base, a piston bore extending from the closed end of the piston to the open end of the piston, and a piston rod extending from the closed end of the piston through the piston bore and partly into the base bore, the piston rod having a first portion in contact with the closed end of the piston and a section of walls of the piston bore and a second portion longer than the first portion, the second portion having a smaller diameter than the first portion, and a spring extending over the second portion and having a first end in contact with a first surface of the first portion connected to the second portion; and a high pressure chamber disposed between the piston bore and the base bore such that a second end of the spring rests at a bottom of the high pressure chamber to bias the spring toward the first surface of the first portion of the piston rod.

In an example embodiment, a pin extending through the piston and the first portion of the piston rod to prevent the piston rod from moving within the piston bore.

In another example embodiment, fluid provided by the inlet supply to the housing bore can the movable base to slide away from the housing seat while the ratchet teeth of the base slide along the ratchet teeth of the pawl, the ratchet teeth being formed at an angle to prevent the movable base from moving towards the housing seat.

In still another example embodiment, the tensioner may further include: at least one pin extending away from the second portion of the piston rod; and at least one corresponding slot formed through the movable base such that the at least one pin extends through the corresponding at least one slot to limit movement of the piston with respect to the movable base by a length equal to the length of the at least one slot.

In yet another example embodiment, fluid flows through the fluid controlled inlet into the base bore and forces the piston to slide out of the housing and away from the base until the at least one pin contacts an end of the respective slot, at which point additional fluid through the inlet fluid supply of the housing forces the movable base to slide through the open end of the housing and away from the housing seat.

The foregoing and other features and utilities of the present inventive concept can also be achieved by providing a tensioner including a housing having an open end, an enclosed end opposite the open end, an inlet fluid supply formed in the enclosed end, a housing bore extending from the open end to a seat formed directly above the inlet fluid supply, the bore having a first diameter extending from the housing seat to a first port extending through a side of the housing, a second diameter wider than the first diameter and extending from the first diameter to the open end of the housing, and a second port disposed above first port approximately equal distance between the first port and the open end of the housing; a seal ring sealed around an entire circumference of a wall of the housing bore adjacent to the open end of the housing, the seal ring having an inner diameter equal to the first diameter of the housing bore; a sleeve disposed within the housing bore and having an open end adjacent the open end of the housing, a enclosed end resting on the housing seat, a controlled inlet formed through the closed end and a flange formed circumferentially around a middle section thereof, the flange having a diameter in sliding contact with the walls of the second diameter of the housing bore such that a first chamber is defined between the first side of the flange and the seal ring and a second chamber is defined between the second side of the flange and a step formed between the first bore diameter and the second diameter bore, the first chamber being in communication with the second port and the second chamber being in communication with the first port; and a piston disposed in the sleeve bore and having a closed end extending out of the open end of the sleeve, an open end opposite the closed end, a piston bore extending from the closed end to the open end and forming a fluid chamber with the sleeve bore, and a piston spring extending from the closed end of the piston to the controlled inlet of the sleeve in a biased state.

In an example embodiment, the tensioner may further include a first fluid supply line connected to the first port and a second fluid supply line connected to the second port such that supplying fluid into the first port applies a fluid pressure to the second side of the flange to move the sleeve away from the housing seat and supplying fluid into the second port applies a fluid pressure to the first side of the flange to move the sleeve toward the housing seat.

In another example embodiment, when a force is applied to the closed end of the piston the fluid pressure in the second chamber prevents the sleeve from moving toward the housing seat while the piston slides toward the closed end of the sleeve while compressing the piston spring.

In still another example embodiment, when the force is removed from the closed end of the piston fluid within the chamber formed between the piston bore and the sleeve bore applies a first hydraulic pressure bias on the piston outward from the sleeve and a piston spring applies a second bias on the piston outward from the sleeve.

In still another example embodiment, the tensioner may further include a solenoid actuator connected to the first fluid supply line and the second fluid supply line to control the pressures in the first and second chambers.

In yet another example embodiment, the tensioner may further include a control valve connected to the first fluid supply line and the second fluid supply line to control the pressures in the first and second chambers.

In yet another example embodiment, the control valve can be a spool valve.

In yet another example embodiment, the controlled inlet formed through the closed end of the sleeve can include a check valve assembly that controls fluid into the chamber formed between the piston bore and the sleeve bore to maintain a constant chamber pressure therein.

In still another example embodiment, the controlled inlet of the movable base includes a check valve fixed thereto and the closed end of the movable base forms a seat for the check valve.

### BRIEF DESCRIPTION OF THE DRAWING

FIG. 1 shows a sectional view of a tensioner according to an example embodiment of the present inventive concept in a new chain position.

FIG. 2 shows a sectional view of a tensioner of the embodiment of FIG. 1 in a worn chain position.

FIG. 3 shows a side sectional view of a tensioner according to an example embodiment of the present inventive concept.

FIG. 4 shows a sectional view of a tensioner according to another example embodiment of the present invention in a new chain position.

FIG. 5 shows a sectional view of the tensioner of FIG. 4 in a worn chain position.

FIG. 6 shows a sectional view of a tensioner according to still another example embodiment of the present inventive concept including a solenoid actuator in a new chain position.

FIG. 7 shows a sectional view of the tensioner of FIG. 6 in a worn chain position.

### DETAILED DESCRIPTION OF THE INVENTION

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings.

The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention pertains to the field of tensioners. More particularly, the invention pertains to a hydraulic tensioner with a moving sleeve or base within a housing of the tensioners.

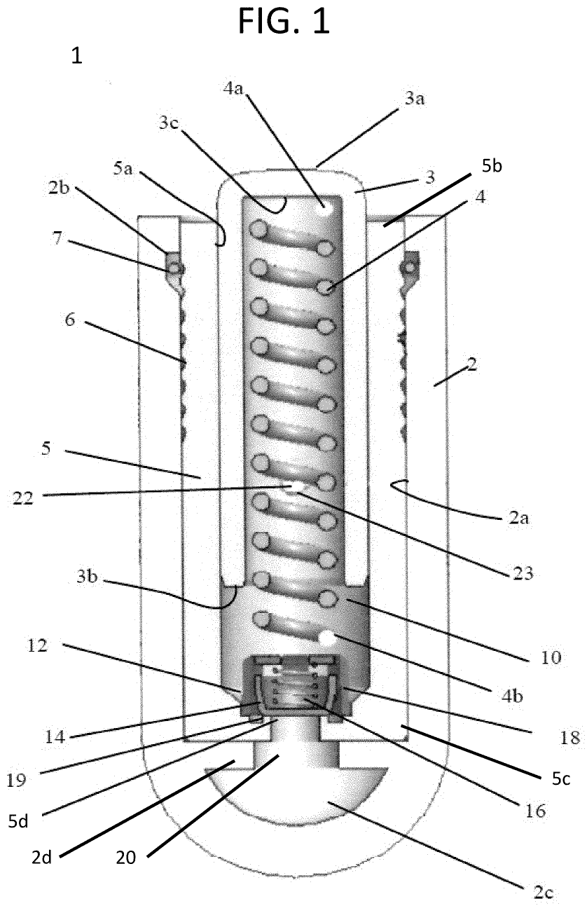

FIG. 1 illustrates an example embodiment of a tensioner 1 usable to apply a tension to a closed loop chain of a chain driven system. The tensioner 1 includes a housing 2 having a housing bore 2a formed therein and extending along a length from an open first end of the housing to a housing seat 2d formed adjacent to an opposite second end of the housing 2. At an inner surface of the housing 2, adjacent to the open first end thereof is formed circumferential cutout 2b about the housing bore 2a adjacent to the first open end of the housing 2 in which a ratchet clip 7 is disposed. Between the housing seat 2d and the second end of the housing is formed an inlet supply 2c which supplies fluid from an engine block (not illustrated to provide brevity to the detailed description) through an inlet 20 formed through the housing seat 2d.

A movable sleeve 5 is disposed within the housing bore 2a and can slide outward of the first open end of the housing 2 due to a fluid supply force applied on the sleeve 5 from the inlet supply 2c and inlet 20 and a force applied to the sleeve 5 by a piston 3, as will be described in more detail below. As illustrated in FIG. 1, a sleeve bore 5a is formed in the sleeve 5 extending from a first end 5b of the sleeve 5 to an area adjacent to a second end 5c of the sleeve 5. The second end 5c of the sleeve 5 initially rests on the housing seat 2d when the closed loop chain is new. Extending through the second end 5c of the sleeve 5 is a sleeve inlet 5d that receives fluid from the inlet 20.

The outer circumference of the moveable sleeve 5 includes ratchet teeth 6 formed along a length of the sleeve 5 towards the first end 5b thereof.

The sleeve bore 5a receives a piston 3 therein which includes a first closed end 3a, a second open end 3b and a piston bore 3c. Within the piston bore 3c is a piston spring 4 that applies an outward bias on the piston 3 outward/away from the housing 2. More specifically, a first end 4a of the piston spring 4 is in contact with an interior side of the first closed end 3a of the piston 3 while a second end 4b of the piston spring 4 extends past the second open end 3b of the piston 3 and into a high pressure chamber 10 within the sleeve 5 to rest on bottom of the sleeve bore 5b. However, a check valve assembly can be secured at the bottom of the sleeve bore 5a to cover the inlet 5d.

A check valve assembly is preferably present between the high pressure chamber 10 and the inlet supply 2c. The check valve assembly 12 can control the amount of fluid that flows into the high pressure chamber 10 from an engine block. However, alternatively to using a check valve assembly 12, the inlet 5d can be formed of a control type device to control the flow of fluid in one direction from the inlet supply 2c to the high pressure chamber 10 while preventing any fluid to flow in the opposite direction back to the inlet supply 2c. Any fluid control device can be used which provides the intended purposes as described herein.

The check valve assembly 12 controls a flow of fluid into the high pressure chamber 10 while preventing any flow of fluid out of the high pressure chamber. When the second end 5c of the sleeve 5 is seated on the housing seat 2d, fluid is received by the check valve assembly 12 from the fluid from the inlet supply 2c via inlet 20.

The check valve assembly 12 can include a check valve disk 14, a retainer 18 that forms the upper surface and sides of the check valve assembly 12, and a check valve spring 16 between the retainer 18 and the check valve disk 14. A seat for the check valve disk 14 is formed by the sleeve bore 5a at a second end 5c of the moveable sleeve 5. The check valve spring 16 applies a spring force on the check valve disk 14 to bias the check valve disk 14 against the seat 19, preventing fluid from flowing from the high pressure chamber 10 to the supply inlet 2c. While a disk check valve is shown, other types of check valves such as a ball-type check valve can be used.

As the sleeve 5 is forced outward of the first open end of the housing 2, and fluid enters the housing bore 2a from the inlet supply 2c and inlet 20 due to fluid supply pressure, the ratchet clip 7 engages the teeth 6 and ratchets with the teeth 6 to move past the clip 7. The engagement between the ratchet teeth 6 and the ratchet clip 7 prevents any backwards force from causing the piston 3 and the sleeve 5 to move towards the housing 2, and the ratchet clip 7 securely rests between two adjacent teeth 6 formed in the outer surface of the sleeve 5, thus preventing the sleeve 5 from sliding back into the housing bore 2a.

The fluid supplied into the housing bore 2a is also received in the high pressure chamber 10 and the piston bore 3c by the check valve assembly 12, thus applying a force on the piston 3 to bias the piston to slide outward of the sleeve 5. Thus, the piston 3 receives an outward force from the piston spring 4 and from a hydraulic force within the high pressure chamber 10.

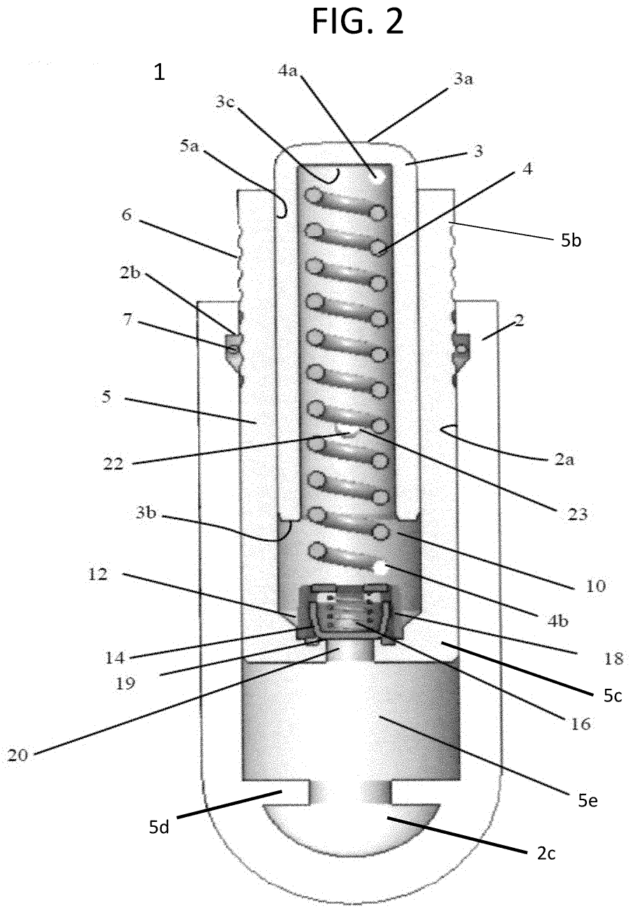

FIG. 2 illustrates the tensioner of FIG. 1 in a state in which the sleeve 5 has extended out of the housing bore 2a to a great extent due to the fluid supply pressure of the fluid supply from the inlet supply 2c, thus keeping the chain under tension when the chain is worn. As a result, a housing pressure chamber 5e is formed between the sleeve 5 and the housing seat 5d. The ratchet clip 7 engages between two adjacent teeth 6 and prevents the sleeve 5 from sliding back into the housing bore 2a. The ratchet clip 7 and the housing pressure in chamber 5e prevent the sleeve 5 from sliding back into the housing bore 2a toward the inlet supply 2c.

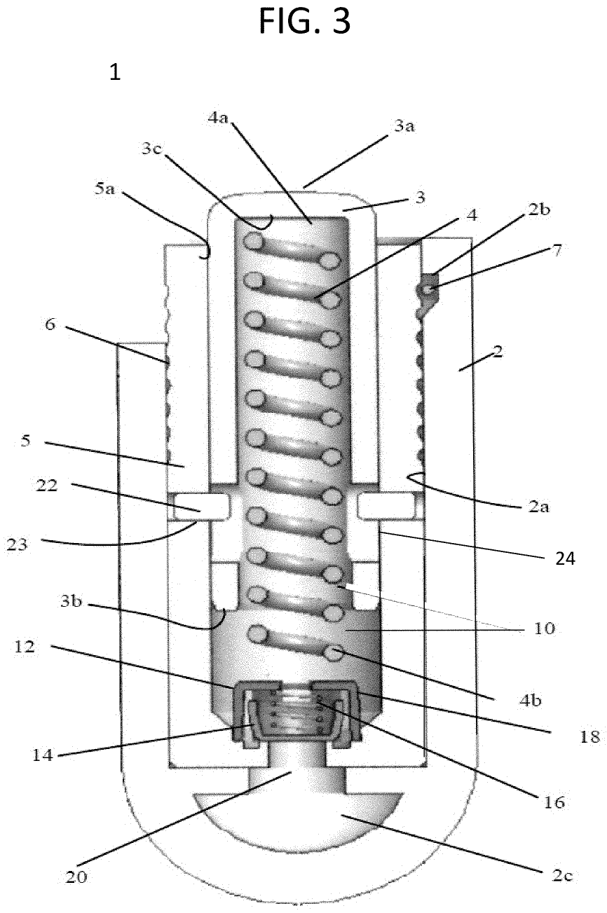

In an alternative embodiment, a pin 22 and pinhole 23 combination, for example, can be provided to limit the distance that the piston 3 can slide outward of the sleeve 5, which is described in detail with reference to FIG. 3.

FIG. 3 illustrates an example embodiment of the tensioner of FIGS. 1 and 2, where a pin 22 can extend through each of a pair of pin holes 23 extending through the sleeve 5 at opposite sides thereof. In other words, the pin holes 23 can be formed 180 degrees apart from each other with respect to the circumference of the sleeve 5. In this example embodiment, a pin 22 extends through each of the pin holes 23 and into respective slots 24 extending between the first end 3a of the piston 3 and the second end 3b of the piston 3. The pins 22 do not extend completely through the slots 24 and thus stop short of contacting the piston spring 4. The pins 22 allow the piston 3 to slide along the sleeve bore 5a by a distance equal to the length of the slots 24. Once the piston 3 is forced outward of the sleeve 5 by a distance equal to the length of slots 24, the end of each slot 24 will contact the respective pin 23 and block the piston 3 from further movement outward of the sleeve 5. At this point the hydraulic pressure within the hydraulic pressure chamber 10 will be transmitted from the piston 3 to the sleeve 5.

Due to a stabilized pressure within the high pressure chamber 10 when the pins 22 are biased against the ends of the slots 24 of the piston 3, the piston 3 will remain stationary within the sleeve 5 while the sleeve 5 slides outward of the housing bore 2a and away from the inlet supply 2c until the chain is under sufficient tension to stop the sleeve 5 from moving further outward of the housing bore 2a. As a result, the sleeve 5 can reduce or eliminate any difference in: a) a force of the piston spring 4; b) a sealing length (piston vs. sleeve) and c) the size of the high pressure chamber 10.

When teeth 6 of the sleeve 5 are engaged with the ratchet clip 7 and the housing pressure chamber 5e is filled with fluid, any back force applied by the chain against the first end 3a of the piston 3 will cause the piston 3 to slide into the sleeve bore 5a along a length of the slots 24, while the ratchet teeth 6 of the sleeve 5 remain engaged with the ratchet clip 7, thus providing a flexible buffer in response to any high pressure back force applied to the piston from the chain.

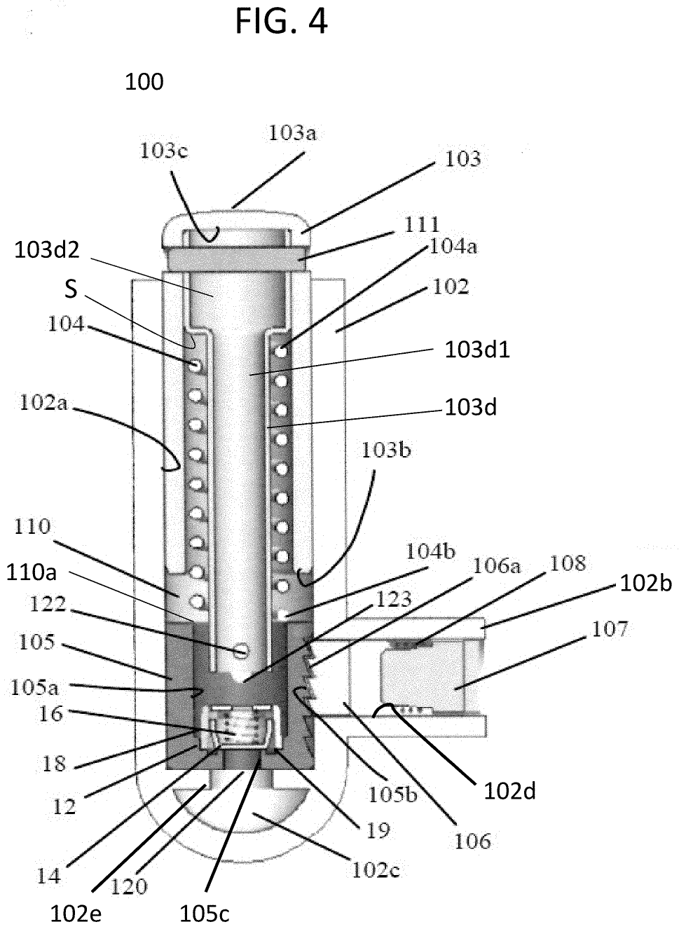

FIG. 4 illustrates another example embodiment of the present inventive concept. In this example embodiment a tensioner 100 includes a housing 102 extending a length having a housing bore 102a formed therein, the housing bore 102a having a first open end and a second enclosed end, opposite the first end, and an inlet supply 102c formed therein to provide fluid to the housing 102 from an engine block or other fluid source.

The tensioner housing 102 according to this example embodiment also includes a housing extension 102b that extends from one side of the housing 102 outward at an angle perpendicular to an axis extending along the length of the housing 102. The housing extension 102b includes an extension bore 102d that extends through the entire housing extension 102b and through the side of the housing 102 to have a fluid connection with the housing bore 102a.

Above the inlet supply 102c is formed a housing seat 102e in which a movable base 105 generally rests during a state where the chain under tension is new. The moveable base 105 has an outer surface in sliding contact with the walls of the housing bore 102a and is configured to slide along the walls of the housing bore 102a. The movable base 105 includes a bore 105a formed therein and an inlet 105c extending through a bottom surface thereof to receive fluid from an inlet 120 formed through the housing seat 102e and the inlet supply 102c. The movable base 105 also includes a check valve assembly disposed therein at the bottom of the base 105. The check valve assembly can be the same as the check valve assembly 12 according to the previous embodiments, or alternatively can be any type of check valve assembly that performs the intended purposes as described herein. The check valve assembly in this example embodiment will be referred to as the same check valve assembly 12 used in the tensioner 1 illustrated in FIG. 1.

Accordingly, the check valve assembly 12 can include a check valve disk 14, a retainer 18 that forms the upper surface and sides of the check valve assembly 12, and a check valve spring 16 between the retainer 18 and the check valve disk 14. A seat for the check valve disk 14 is formed by the sleeve bore 105a at a second end 105c of the moveable sleeve 105. The check valve spring 16 applies a spring force on the check valve disk 14 to bias the check valve disk 14 against the seat 19, preventing fluid from flowing from the high pressure chamber 110 to the supply inlet 102c. The check valve assembly 12 also controls an amount of fluid that flows from the inlet 120 and the base inlet 105c to the movable base bore 105a.

Along a side of the movable base 105, ratchet teeth 105b are formed to extend along an outer length thereof. The ratchet teeth 105b are positioned to face the extension bore 102d of the housing 102. Disposed within the bore 102d of the housing extension 102b is a pawl 106 that includes pawl ratchet teeth 106a at a first end in contact with the ratchet teeth 105b of the movable base 105. The pawl 106 is biased by a pawl spring 108 at a second end thereof opposite to the first end including the pawl teeth 106a. A plug 107 can be fixed within the extension bore 102d to secure the spring 108 under a constant bias against the pawl 106, thus maintaining the pawl ratchet teeth 106a in contact with the ratchet teeth 105b of the movable base 105 at all times. Alternatively to using a plug, the housing can be formed such that the extension is closed at the end thereof.

A piston 103 can be disposed within the housing bore 102a and can include a first enclosed end 103a and a second open end 103b. The first end 103a of the piston 103 extends out of the housing bore 102a and the second end 103b of the piston 103 faces the movable base 105 and is open to a fluid connection with a high pressure chamber 110 disposed between the movable base 105 and the piston 103. The piston 103 also includes a piston bore 103c formed therein extending from the first end 103a of the piston 103 through the entire length of the second end 103b of the piston 103 to the high pressure chamber 110. A piston rod 103d is disposed within the piston bore 103c. Alternatively, to provide for a lighter design, the piston rod 103d can be a tube formed of a light material such as, for example plastic, fiberglass, or any other material that will perform the intended purposes as described herein. The piston rod 103d includes a first section 103d1 having a first end that extends through the opening in the second end 103b of the piston 103, through the high pressure chamber 110 and into the bore 105a of the movable base 105. The piston rod 103d also includes a second section 103d2 that is integrally formed with a second end of the first section 103d1 and has a larger diameter than the first section 103d1. The outer surface of the second section 103d2 of the piston rod 103d is in contact with the entire inner surface of the piston bore 103c at the first end 103a of the piston 103.

A pin 111 can be disposed through the piston 3 adjacent the first end 103a and through the second section 103d2 of the piston rod 103d to maintain the piston rod 103 stationary within the piston chamber 103c.

Surrounding the first section 103d1 of the piston rod 103d is a piston spring 104 that has a first end 104a in contact with a first end of the second section 103d2 of the piston rod 103 that is integrally formed with the first section 103d1 to form a shoulder “S” therebetween. A second end 104b of the spring 104 extends into the high pressure chamber 110 to rest on a bottom surface 110a of the high pressure chamber 110. The high pressure chamber 110 includes the fluid volume defined by an area between the bottom 110a of the high pressure chamber 110, the walls of the piston chamber 103c and the shoulder S of the piston rod 103d.

In an example embodiment of the tensioner of FIG. 4, a pair of pins 122 can extend outward from opposite outer surfaces of the first section 103d1 of the piston rod 103d and into corresponding slots 123 formed in opposite sides of the movable base 105. The pins 122 can be positioned at a 180 degree separation from each other and are provided to limit movement of the piston rod 103d and piston 103 with respect to the high pressure chamber 110 and the movable base 105 by a distance equal to the length of the slots 123 formed in the movable base 105.

In operation, fluid force from fluid flowing through the inlet 120 from the inlet supply 102c forces the piston 103 outward of the movable base 105 by a distance equal to the length of the slots 123, until the pins 122 contact the ends of the slots 123. Once the piston 103 is refrained from sliding further outward and away from the movable base 105 as a result of the pins 122 being stopped by the upper end of the respective slots 123, the movable base 105 is forced, by the pins 122 pressed against the ends of the slots 123 as the piston 103 is forced outward, to slide outward away from the housing seat 102e along the walls of the housing bore 102a until the first end 103a of the piston 103 applies a tension on a closed loop chain of a chain drive system (not illustrated to provide brevity of the detailed description). As the movable base 105 slides outward along the walls of the housing bore 102a, the base ratchet teeth 105b ratchet with the pawl ratchet teeth 106a. A biasing engagement of the pawl ratchet teeth 106a with the base ratchet teeth 105b is maintained by the bias of the spring 108.

When sufficient tension is applied to the chain by the piston 103, the base ratchet teeth 105b engage the pawl ratchet teeth 106a such that the movable base 105 cannot slide back into the housing bore 2a toward the inlet supply 102c. Both sets of teeth 105b and 106a are formed at an angle such that the base ratchet teeth 105b (and movable base 105) can slide along the pawl ratchet teeth 106a in one direction away from the inlet supply 102c by biasing the pawl toward the pawl spring 108. Due to the engagement of the base ratchet teeth 105b and the pawl ratchet teeth 106a the movable base 105 cannot slide back toward the inlet supply 102c. Once the chain is under tension and the movable base 105 stops sliding outward, the pawl ratchet teeth 106a become fully engaged with the base ratchet teeth 105b as a result of the continuous bias of the pawl spring 108 against the pawl 106.

While the chain of a chain drive system is being tensioned and the base ratchet teeth 105b are engaged with the pawl ratchet teeth 106a, the chain can occasionally apply a back force against the piston 103. When a back force occurs, the first end 103a of the piston 103 will receive this force. Since the movable base 105 is prevented from sliding in a direction back toward the housing seat 102e, the piston 103 will compress the the spring 104 as the piston 10 slides toward the moveable base 105 while the pins 122 extending from the piston rod 103d slide along a length of the slots 123 until the pins 122 contact the far ends of the slots 123. As a result, the back force caused by the chain under tension can be absorbed by the compression of the piston spring 104 between the shoulder S of the piston rod 103d and the bottom 110a of the high pressure chamber 110 and the hydraulic pressure of the high pressure chamber 110. In other words, the hydraulic pressure within the high pressure chamber 110 and the bias of the piston spring 104 together provide a flexible buffer or counter force to the back force, while the movable base 105 and the high pressure chamber 110 remain stationary. As the back force dissipates, the tensioning force continues to be applied to the chain due to the force of the piston spring 104 against the shoulder S of the piston rod 103d and the hydraulic pressure within the high pressure chamber 110.

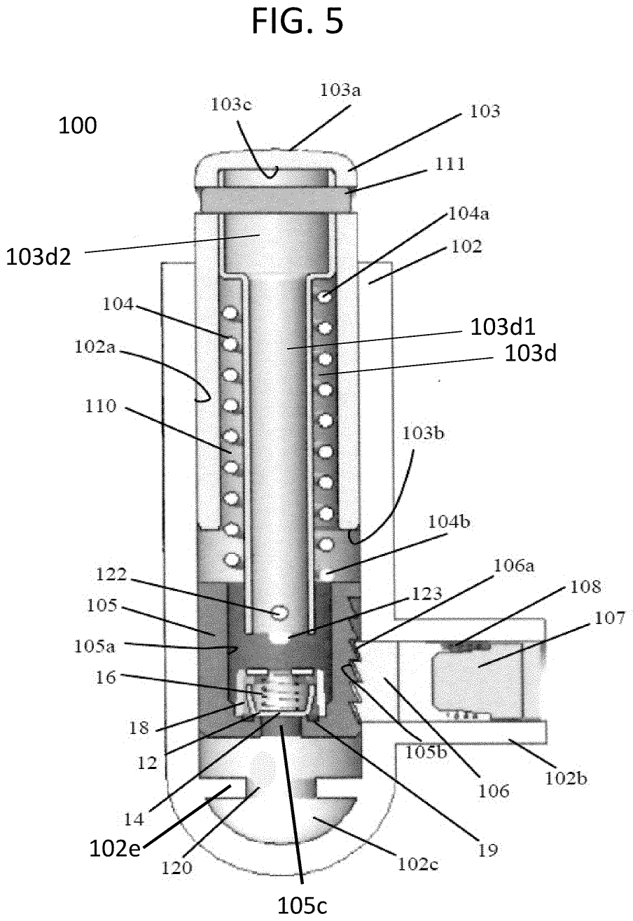

FIG. 5 illustrates the configuration of the tensioner 100 when the closed loop chain receiving the tension becomes worn or extended. When the chain wears and becomes extended, the piston 103 is required to be forced further outward to apply more tension to the chain. Since the piston rod 103d and piston 103 combination is limited in movement outward by the distance the pins 122 can move along the length of their respective slots 123, the movable base 105 will be forced to slide outward from the housing chamber 102a due to the constant force applied to the movable base 105 by the inlet supply 102c feeding fluid against the bottom of the movable base 105 as well as the force of the piston rod 103d on the movable base 105 due to the linkage of the pins 122 and respective slots 123. The movable base 105 will slide along the walls of the housing bore 102a away from the housing seat 102e while the base ratchet teeth 105b slide further over the pawl ratchet teeth 106a, thus forcing the pawl 106 against the pawl spring 108 until tension is once again sufficiently applied to the chain. As the inlet supply 102c supplies fluid against the bottom of the movable base 105, a space within the housing bore 102a between the inlet supply 102c and the bottom of the movable base 105 increases and fills with the fluid to create a fluid pressure chamber under the movable base 105.

When the movable base 105 stops sliding outward along the walls of the housing bore 102a due to sufficient tension being applied to the chain, the base ratchet teeth 105b become fully engaged with the pawl ratchet teeth 106a as the pawl 106 is continuously biased by the pawl spring 108. This process will continue as the chain becomes more worn until the movable base 105 is fully extended and rests on the uppermost pawl tooth 106a.

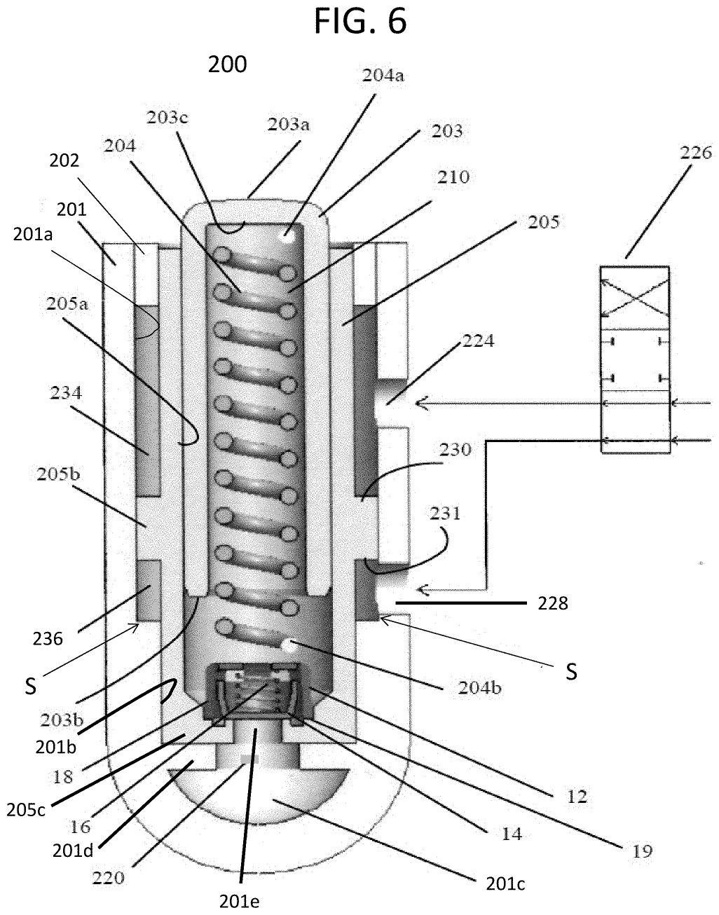

FIG. 6 illustrates a tensioner 200 according to another example embodiment of the present inventive concept. The tensioner 200 is similar to the tensioner 1 of FIG. 1, however, tensioner 200 does not rely on a ratcheting system to control positioning of a piston, but instead uses fluid pressures, as described in detail below.

Tensioner 200 includes a housing 201 having a bore extending through a first open end of the housing 201 down to an opposite enclosed end of the housing 201. In this example embodiment the housing bore includes a first bore diameter 201a and a second bore diameter 201b, the second bore diameter 201b being disposed toward the enclosed end of the housing 201 and the first bore diameter 201a extending between the second bore diameter 201b and the open end of the housing 201. The first bore diameter 201a is larger than the second bore diameter 201b, thus forming a step “S” between the first bore diameter 201a and the second bore diameter 201b. The step S is preferably perpendicular to the inner surfaces of the first bore diameter 201a and the second bore diameter 201b.

A sealing ring 202 is disposed within the first bore diameter 201a at the open end of the housing 201 and is fixed tightly against the walls of the first bore diameter 201a. An inner diameter of the seal ring 202 is the same as the second bore diameter 201b.

The second enclosed end of the housing 201 includes a housing seat 201d. Between the bottom of the housing 201 and the housing seat 201d is formed an inlet fluid supply 201c. An inlet 220 is formed through a center of the housing seat 201d to receive fluid into the first housing bore 201a and the second housing bore 201b from the supply inlet 201c. The fluid supply inlet 201c can receive fluid from and engine block.

Inserted into the first bore diameter 201a and second bore diameter 201b is a movable sleeve 205. The movable sleeve 205 extends the entire length of the first and second bore diameters 201a and 201b and has an outer circumference slightly less than the inner diameter of the seal ring 202 and the second bore diameter 201b, such that the movable sleeve 205 can slide along the walls of the second housing bore diameter 201b and the inner diameter of the seal ring 202. The movable sleeve 205 rests on the housing seat 201d of the housing 201 above the inlet supply 201c. The housing seat 201d includes an inlet 201e formed through a middle thereof to receive fluid from the inlet supply 201c and inlet 220.

The sleeve 205 includes a bore 205a formed therein to receive a piston 203. Similar to the sleeve illustrated in FIG. 1, sleeve 205 includes a check valve assembly 12 disposed at the inlet 201e to control an amount of fluid that can flow into the sleeve bore 205a. The check valve assembly 12 can include a check valve disk 14, a retainer 18 that forms the upper surface and sides of the check valve assembly 12, and a check valve spring 16 between the retainer 18 and the check valve disk 14. A seat for the check valve disk 14 is formed by the sleeve bore 205a at a second end 205c of the moveable sleeve 105. The check valve spring 16 applies a spring force on the check valve disk 14 to bias the check valve disk 14 against the seat 19, preventing fluid from flowing from the high pressure chamber 210 to the supply inlet 202c.

Within the sleeve bore 205a, the piston 203 is positioned to have an outer diameter in sliding contact with the inner walls of the sleeve bore 205a, a first closed end 203a that extends out of the sleeve bore 205a and a second open end 203b that faces the check valve assembly 12. A piston bore 203c extends from an inner surface of the first closed end 203a to the open end 203b and forms a high pressure chamber 210 with the sleeve bore 205a. Within the piston bore 203c is a piston spring 204 that has a first end 204a in contact with the inner surface of the first end 203a and a second end 204b that is in contact with the check valve assembly 12. The piston spring 204 applies a biasing force outward on the piston 203 when a force is applied from the chain to the first end 203a of the piston. For example, when a span of a closed loop chain applies a back force which transfers to the first end 203a of the piston 203, the piston spring 204 applies a counter force to the inner surface of the first end 203a of the piston 203. In addition to the force applied by the piston spring 204 is another force applied to the piston 203 by a hydraulic pressure of the fluid within the high pressure chamber 210.

The sleeve 205 also includes a sleeve flange 205b that extends circumferentially around an outer surface of the sleeve 205 and can be formed approximately about the center of the sleeve 205. It is to be noted that the length of the first bore diameter 201a and the positioning of the sleeve flange 205b can be positioned according to the intended results of movement of the sleeve 205 with respect to the housing 201. The sleeve flange 205b has an outer diameter that is in sliding contact with the walls of the first housing bore 201a. The sleeve flange 205b is formed at a position which forms a first chamber 234 with the seal ring 202, the first housing bore 201a and the outer surface of the sleeve 205. The sleeve flange 205b also forms a second chamber 236 with the shoulder S, a wall of the first housing bore 201a and the outer surface of the sleeve 205.

Along one side of the housing 201 are formed a first port 224 extending through the housing 201 and into the first chamber 234 and a second port 228 extending through the housing 201 and into the second chamber 236 such that the sleeve flange 205b is disposed between the first port 234 and the second port 228 and can slide between the first port 234 and the second port 228.

Fluid is supplied to both the first chamber 234 and the second chamber 236 via respective ports 224 and 228. Although not illustrated, first and second supply lines can be connected to both ports 224 and 228 to supply fluid to the first chamber 234 and the second chamber 236, respectively. A solenoid actuator 226 can be used to switch fluid flow between the first and second supply lines to the first port 224 and the second port 228. Alternatively, a control valve can be implemented to selectively supply fluid between the first port 224 and the second port 228. A spool valve can be used alternatively to the solenoid actuator 226 or the control valve.

When fluid is provided from the inlet supply 201c to force the sleeve 205 and piston 203 outward of the housing 201 and away from the housing seat 201d, fluid in the first chamber 234 can apply a counter force on a first side 230 of the flange 205b to limit the distance in which the sleeve 205 extends outward of the housing bore 201a and past the seal ring 202 to a distance that permits the sleeve 205 and piston 203 combination to apply a sufficient tension to the closed loop chain. At this time the solenoid actuator 226 has the supply line to the first port 224 closed off, which causes the chamber 234 to become pressurized as the sleeve 205 moves away from the housing seat 201d. The tensioner 200 according to this example embodiment eliminates the need for pins and corresponding slots between the piston and sleeve according to previous embodiments described above. Instead of requiring a pin and slot combination to control the movement of the piston with respect to a sleeve, the sleeve 205 according to this example embodiment can be adjusted to any desired position with a solenoid such as the solenoid 226. Accordingly, the piston 203 can be positioned to be completely in a retracted position inside the sleeve 205 and can be extended to a maximum amount (pumped out) in a warn chain condition. Alternatively, the sleeve 205 can be controlled by a solenoid to be extended outward of the tensioner housing 201 to any desired amount. In fact, the hydraulic force within the high pressure chamber 210 can be controlled to be virtually the same as the mechanical force of the spring 204 by controlling the amount of fluid in the first chamber 234 and the second chamber 236.

When the tensioner 200 is tensioning the closed loop chain during a high chain load, during operation, the force from the high chain load pushes the piston 203 toward the sleeve 205, thus transferring this force to the sleeve 205. This force is resisted by the fluid in the second chamber 236 as a result in the fluid applying a force against a second side 231 of the flange 205b. At this time the solenoid actuator 226 has the supply line to the port 228 closed off, thus preventing any fluid from exiting the chamber 236. As a result of the force applied to the sleeve 205 the chamber 236 becomes pressurized.

Once the force due to the high chain load is removed from the piston 203, essentially depressurizing the chamber 236, the solenoid actuator 226 can switch to open the supply line to supply fluid through the second port 228 and into the second chamber 236. The fluid provided to the chamber 236 applies a force on the second side 231 of the flange 205b to maintain the sleeve 205 and piston 203 at their current position, thus continuing to apply tension to the chain. The fluid in the first chamber 234 limits the movement of the sleeve 205 beyond the travel necessary to maintain the position of the piston 203 to continue to provide a sufficient tension to the chain. The force within the chamber 234 applies a bias against the first side 230 of the flange 205b. At this time the solenoid actuator 226 has the supply line to the port 224 closed off, thus preventing fluid from exiting the chamber 234.

While the sleeve 205 is maintained in stationary position to keep a constant tension on the chain, any back force from the chain can be buffered by the piston 203 as the piston 203 slides into the sleeve bore 205a and the piston spring 204 and the hydraulic pressure within the high pressure chamber 210 both apply a counter-biasing force outward. Once the back force discontinues, the piston 203 can extend back out of the sleeve bore 205a by the bias applied to the piston 203 by the compressed piston spring 204 and the hydraulic pressure from the fluid in the high pressure chamber 210.

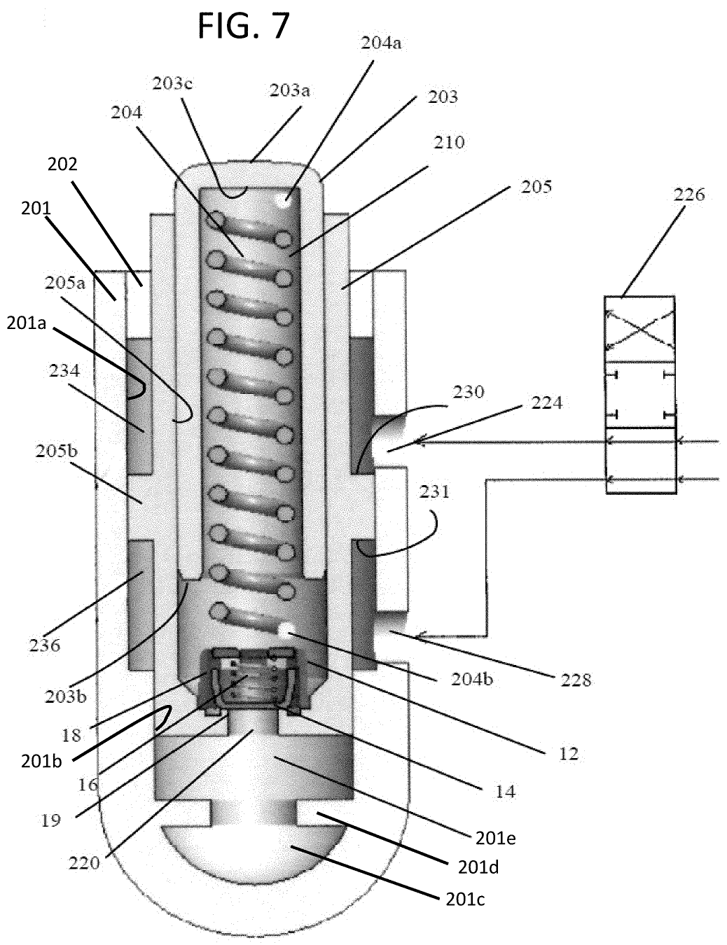

FIG. 7 illustrates a configuration of the tensioner 200 in a state where the closed loop chain is worn. When the chain becomes worn it becomes extended or loose, thus requiring the tensioner 200 to increase the tension on the chain by extending the sleeve 205 and piston 203 outward of the housing bore 201a. At this point fluid is supplied by the inlet supply 201c and through the inlet 220 to force the sleeve 205 away from the housing seat 201d. As a result, a void between the seat 201d and the sleeve 205 creates a new chamber 201e which is filled with the fluid provided by the inlet supply 201c through the inlet 220. The solenoid actuator 226 also opens the supply line to the port 228 to increase the amount of fluid in the second chamber 236, thus applying a pressure on the second side 231 of the flange 205b to prevent the sleeve 205 from sliding back toward the housing seat 201d.

This process is performed continuously to maintain a consistent tension on the closed loop chain of the chain drive system.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tensioner comprising:
a housing having an open end, an enclosed end opposite the open end, an inlet fluid supply formed in the enclosed end, a housing bore extending from the open end through the housing to a seat formed directly above the inlet fluid supply, and a ratchet clip disposed in a groove formed circumferentially around the housing bore adjacent to the open end thereof;
a movable sleeve slidingly disposed in the housing bore, the sleeve including an open end adjacent the open end of the housing, a closed end in contact with the seat, a bore extending from the open end through the sleeve to the closed end, and ratchet teeth formed along an outer circumference thereof such that the ratchet clip frictionally engages with consecutive ratchet teeth as the sleeve moves outward of the housing bore; and
a piston slidingly disposed in the sleeve bore, the piston having a closed end adjacent the open end of the sleeve, an open end in fluid communication with the sleeve bore to form a high pressure chamber, and a piston spring extending from an inner side of the closed end to the check valve.

2. The tensioner according to claim 1, wherein fluid provided by the inlet fluid supply forces the moveable sleeve and piston to slide away from the housing seat.

3. The tensioner according to claim 2, wherein the sleeve further comprises a controlled inlet extending through the closed end of the sleeve to control a flow of fluid into the sleeve bore.

4. The tensioner according to claim 3, wherein the controlled inlet of the sleeve includes a check valve fixed thereto and the closed end of the sleeve forms a seat for the check valve.

5. The tensioner according to claim 3, further comprising:
at least one slot formed lengthwise through the piston; and
at least one pin extending inward from a wall of the sleeve through a corresponding at least one slot, the at least one slot having a length to control sliding movement of the piston along a length of the sleeve bore.

6. A tensioner comprising:
a housing having an open end, an enclosed end opposite the open end, an inlet fluid supply formed in the enclosed end to receive fluid from an external source, a housing bore extending from the open end to a seat formed directly above the inlet fluid supply, and an extension extending outward from the housing and forming an extension bore in communication with the housing bore;
a movable base disposed in the housing bore and having an open end facing toward the open end of the housing, a closed end including a fluid controlled inlet extending therethrough resting on the housing seat, a bore extending from the open end to the closed end, and ratchet teeth formed along a length of a section of the outer surface of the base facing the extension bore;
a pawl having pawl ratchet teeth, the pawl slidingly received within the extension and continuously biased to engage the pawl ratchet teeth with the ratchet teeth of the moveable base;
a piston slidingly disposed in the housing bore, the piston including a closed end adjacent the open end of the housing, an open end facing the open end of the base, a piston bore extending from the closed end of the piston to the open end of the piston, and a piston rod extending from the closed end of the piston through the piston bore and partly into the base bore, the piston rod having a first portion in contact with the closed end of the piston and a section of walls of the piston bore and a second portion longer than the first portion, the second portion having a smaller diameter than the first portion, and a spring extending over the second portion and having a first end in contact with a first surface of the first portion connected to the second portion; and
a high pressure chamber disposed between the piston bore and the base bore such that a second end of the spring rests at a bottom of the high pressure chamber to bias the spring toward the first surface of the first portion of the piston rod.

7. The tensioner according to claim 6, wherein the piston further comprises:
a pin extending through the piston and the first portion of the piston rod to prevent the piston rod from moving within the piston bore.

8. The tensioner according to claim 7, wherein fluid provided by the inlet supply to the housing bore forces the movable base to slide away from the housing seat while the ratchet teeth of the base slide along the ratchet teeth of the pawl, the ratchet teeth being formed at an angle to prevent the movable base from moving towards the housing seat.

9. The tensioner according to claim 8, further comprising:
at least one pin extending away from the second portion of the piston rod; and
at least one corresponding slot formed through the movable base such that the at least one pin extends through the corresponding at least one slot to limit movement of the piston with respect to the movable base by a length equal to the length of the at least one slot.

10. The tensioner according to claim 9, wherein fluid flows through the fluid controlled inlet into the base bore and forces the piston to slide out of the housing and away from the base until the at least one pin contacts an end of the respective slot, at which point additional fluid through the inlet fluid supply of the housing forces the movable base to slide through the open end of the housing and away from the housing seat.

11. A tensioner comprising:
a housing having an open end, an enclosed end opposite the open end, an inlet fluid supply formed in the enclosed end, and a housing bore extending from the open end to a seat formed directly above the inlet fluid supply, the bore having a first diameter extending from the housing seat to a first port extending through a side of the housing, a second diameter wider than the first diameter and extending from the first diameter to the open end of the housing, and a second port disposed above first port approximately equal distance between the first port and the open end of the housing;
a seal ring sealed around an entire circumference of a wall of the housing bore adjacent to the open end of the housing, the seal ring having an inner diameter equal to the first diameter of the housing bore;
a sleeve disposed within the housing bore and having an open end adjacent the open end of the housing, a closed end resting on the housing seat, a controlled inlet formed through the closed end, a bore extending from the open end to the closed end, and a flange formed circumferentially around a middle section thereof, the flange having a diameter in sliding contact with the walls of the second diameter of the housing bore such that a first chamber is defined between the first side of the flange and the seal ring and a second chamber is defined between the second side of the flange and a step formed between the first bore diameter and the second diameter bore, the first chamber being in communication with the second port and the second chamber being in communication with the first port; and
a piston disposed in the sleeve bore and having a closed end extending out of the open end of the sleeve, an open end opposite the closed end, a piston bore extending from the closed end to the open end and forming a fluid chamber with the sleeve bore, and a piston spring extending from the closed end of the piston to the controlled inlet of the sleeve in a biased state.

12. The tensioner according to claim 11, further comprising:
a first fluid supply line connected to the first port and a second fluid supply line connected to the second port such that supplying fluid into the first port applies a fluid pressure to the second side of the flange to move the sleeve away from the housing seat and supplying fluid into the second port applies a fluid pressure to the first side of the flange to move the sleeve toward the housing seat.

13. The tensioner according to claim 12, wherein when a force is applied to the closed end of the piston the fluid pressure in the second chamber prevents the sleeve from moving toward the housing seat while the piston slides toward the closed end of the sleeve while compressing the piston spring.

14. The tensioner according to claim 13, wherein when the force is removed from the closed end of the piston fluid within the chamber formed between the piston bore and the sleeve bore applies a first hydraulic pressure bias on the piston outward from the sleeve and a piston spring applies a second bias on the piston outward from the sleeve.

15. The tensioner according to claim 12, further comprising:
a solenoid actuator connected to the first fluid supply line and the second fluid supply line to control the pressures in the first and second chambers.

16. The tensioner according to claim 11, further comprising:
a control valve connected to the first fluid supply line and the second fluid supply line to control the pressures in the first and second chambers.

17. The tensioner according to claim 16, wherein the control valve is a spool valve.

18. The tensioner according to claim 12, wherein the controlled inlet formed through the closed end of the sleeve comprises a check valve assembly that controls fluid into the chamber formed between the piston bore and the sleeve bore to maintain a constant chamber pressure therein.

19. The tensioner according to claim 11, wherein the controlled inlet of the movable base includes a check valve fixed thereto and the closed end of the movable base forms a seat for the check valve.
